(19) United States
(12) Patent Application Publication
(10) Pub. No.: US 2017/0080630 A1
(43) Pub. Date: Mar. 23, 2017

(54) System and method for bending a hollow core sheet using rods

(71) Applicant: Marc-Andre Racine, Fort McMurray (CA)

(72) Inventor: Marc-Andre Racine, Fort McMurray (CA)

(21) Appl. No.: 15/243,997

(22) Filed: Aug. 23, 2016

(30) Foreign Application Priority Data
Sep. 23, 2015 (GB) 1516884.2

(51) Int. Cl. B29C 53/24

(52) U.S. Cl. CPC B29C 53/24; B29K 2023/12

(57) ABSTRACT

A system and method for bending a hollow core sheet using rods has at least one bendable rod that is inserted inside a channel of a hollow core sheet so as to strengthen it and increase its malleability, which offers the possibility of pliancy to the hollow core sheet so that it can hold a shape. The reinforcing bendable rod is held in place via an applied angled force inside the walls of the channels. The hollow core sheet is then bent into a desired shape to create useful objects.

### FIELD OF THE INVENTION

The present invention relates generally to hollow core corrugated sheets made of plastic such as polypropylene (PP) or polyethylene (PE), but more particularly to a system and method of reinforcing those sheets so that rigid shapes and angles can be imparted to them so as to make various products thereof.

### BACKGROUND OF THE INVENTION

Hollow core sheets, also known as corrugated sheets have a hollow space between two bonded panels kept spaced apart by way of a plurality of ribs made out of the same material. The manufacturing process is generally by way of extrusion and the ribs create a plurality of co-joined channels which are hollow. So, the sheet, in volume, is made mostly of hollow space, hence the name “hollow core sheet”. The thickness of the sheet, do to its hollow core, gives it strength, and the plastic gives it a long life. The channels can be triangular shaped like sine waves, such as commonly seen in corrugated carton boxes. In some instances, some cardboard or plastic corrugated materials have only one sheet bonded to a sine wave corrugated sheet. See FIG. 4 for examples.

Hollow core sheets are used to make a wide range of products from packaging, advertising signage, stationery, shock resistant boxes etc. At the moment, hollow core sheets have limitations on their applications due to the limitations of their strength and malleability.

There hence exists a need for strengthening hollow core sheets in order to expand their applications.

### SUMMARY OF THE INVENTION

In view of the foregoing disadvantages inherent in the known devices now present in the prior art, the present invention, which will be described subsequently in greater detail, is to provide objects and advantages which are:

To provide for a means of reinforcing hollow core sheets so as to give the possibility of producing designated shape applications.

It is another advantage of this invention to provide a reinforcement to the hollow core sheet which eliminates the use of a separate application of adhesive material.

It is yet another advantage of this invention to reinforce the hollow core sheet without subjecting it to heat damage.

Still another advantage is to provide a low cost process for manufacturing reinforced hollow core sheets manually or mechanically.

In order to do so, the invention comprises at least one rod wherein the at least one rod is inserted inside a channel forming an integral part of the hollow core sheet. The at least one rod has a maximum breadth of 75% of the internal breadth of the channel it is inserted in when making a rounded edge bend, and a minimum of 50% of the thickness of the hollow sheet it is inserted in when doing a sharp edge bend.

The rod is bent to a minimum angle in relation to its length and its relative size ratio to the inside breadth of the channel so as to prevent sliding within the channel.

The hollow core sheet's thickness is multiplied by 0.5 which is then multiplied by the number of bends so as to determine how much shorter the rod needs to be in relation to the length of the hollow core sheet so as to not stick out from the ends of the hollow core sheet.

The system can be implemented by following steps which include: having at least one rod that is is bent to a minimum angle in relation to its length and its relative size ratio to the thickness of the sheet, and then is inserted into a channel forming part of a hollow core sheet so as to prevent sliding within the channel; said at least one rod being calculated as having a maximum breadth of 75% of the internal breadth of the channel it is inserted in when making a rounded edge bend; and calculated to be a minimum of 50% of the thickness of the hollow sheet if it is for doing a sharp edge bend. Bending the at least one rod to create a desired shape.

The foregoing and other objects, features, and advantages of this invention will become more readily apparent from the following detailed descriptions of a preferred embodiment of the innovation with reference to the accompanying drawings as is shown and described, by way of examples. As will be realized, the invention is capable of other and different use, and its details can be modified in various ways, all without departing from the invention. For example, the invention can come in varying sizes and shapes with variations in the material of the bendable rod used, sizes, design and assembly of components. Accordingly, the drawings and description are to be regarded as illustrative in nature, and not as restrictive.

### BRIEF DESCRIPTION OF THE DRAWINGS

FIG. 1 End view of a hollow core sheet with rods of the prior art.

FIG. 2 End view of a hollow core sheet with 75% rods.

FIG. 3 End view of a hollow core sheet with 50% rods.

FIG. 4 Cutaway side views of a variety of possible channel shapes.

FIGS. 5A-B Top and side see through schematic views showing various types of bend angles.

FIGS. 6A-B Isometric views showing an object having sharp edge bends, and an object having soft edge bends.

### DETAILED DESCRIPTION

A hollow core sheet (10) having a bendable reinforcement rod (12) inserted inside a channel (14) forming part of the hollow core sheet (10). The channel (14) can have one of a variety of shapes and sizes. One or more rods (12) can be inserted in any one or several locations in the sheet (10), and they can be of different material lengths, widths, shapes, and thicknesses. The number of rods (12) used can also influence the level of strength and the type of shapes achievable.

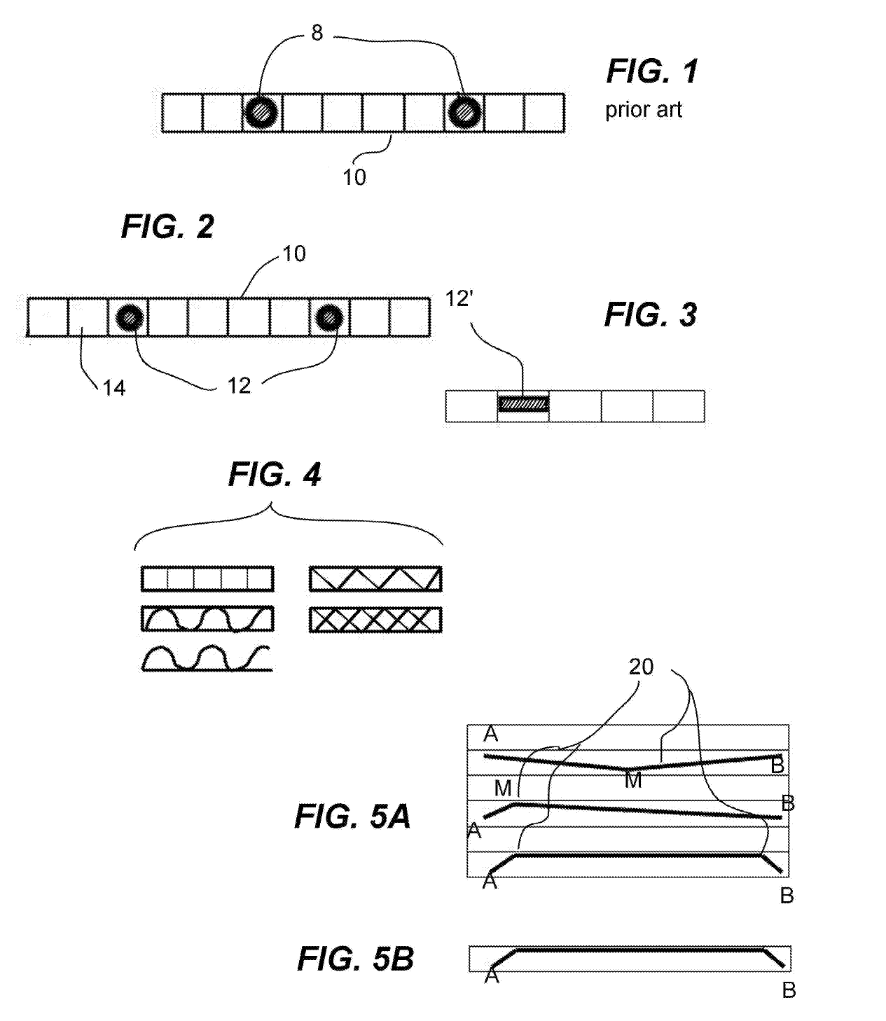

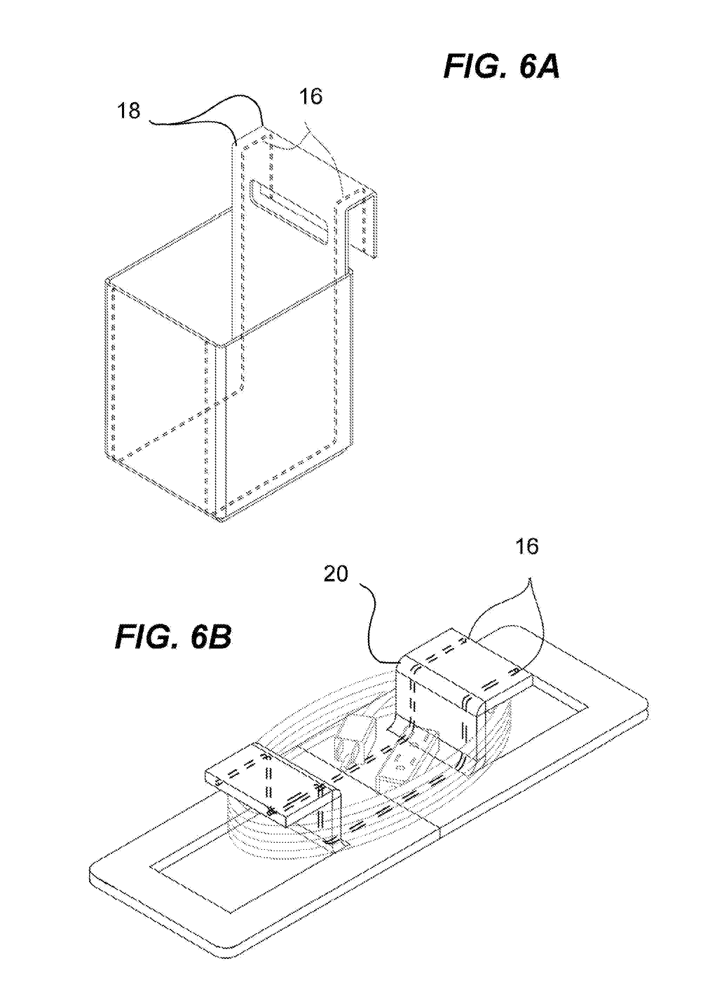

Preferably, the inserted rods (12) have a maximum outside diameter (O.D) of 75% of the internal diameter (I.D) (or width) of the channel (14) so as to prevent any stretching of the channel (14), which could weaken the board when curves or folds are made to create a desired shape. The prior art, as shown in FIG. 1 uses full size rods (8) (100% O.D.) for stiffening a panel. There is no concern for bending issues since the purpose is to bend the panel but rather to give it stiffness. Used as is, bending the rod (8) would result in weakening the board (10).

When a bend (16) needs to have a sharp edge (18) when bent, rather than a rounded edge (20), a flat bar (12′) is used wherein its thin side must not exceed 50% of the thickness of the channel (14).

If the rod (12) is not inserted deep enough into the channel (14), it will stick out from the end of the sheet (10) when a bend is made. It is thus important to cut the rods (12) slightly shorter than the board (10) it is to be inserted in. How shorter is calculated relative to the number of bends used in creating a shape. The size of the rod (12) that is inserted within the channel (14) is directly proportional to the thickness of the sheet (10) and the number of bends required for a particular shape.

For example: Nb=Number of bends and T=Thickness of the sheet (10).

When many bends are needed to obtain a desired form, it is important to multiply the number of bends (Nb) with the thickness (T) of the sheet (10). The formula is thus:

T×0.5×Nb

To help stabilize the rod (12) inside the channel (14), a minimum bend angle (20) is needed to secure the rod (12) inside the channel (14). For clarity, the bend angle (20) has been exagerated in FIG. 5.

Also, the figure shows the bend is made across the width of the board (10) but it could also be made across the thickness of the board (10). The angle that is applied to the rod (12) which is inserted into a channel (14) is slightly less than 180 degrees. In other words, it is not a flat rod (12) but has a small bend that creates friction against the sides of the channel (14) so that the rod (12) just won't simply slide out.

The determined angle applied to the rod (12) is measured in function of length of the rod (12) and the size of channel (14).

Mid-point (M) segment=Point A+B\2A - - - M - - - B, where AM=BM.

Obviously, the longer the rod, the lesser the required angle of the bend. Also included in the calculation is the thickness of the rod (12), whether 50% or 75% of the size of the channel (14). The desired result is that the angle of the bend will allow for the rod (12) or flat bar (12′) to touch the inside of the channel (14) at points A, M, B.

FIG. 5 shows variations where there is more than one angle bend which results in most of the rod (12) touching one side of the channel and only points A and B touching the opposite side of the channel. Also, the “M” point does not need to be in the middle.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for bending a hollow core sheet using at least one rod wherein the at least one rod is inserted inside a channel forming an integral part of the hollow core sheet; said at least one rod having a maximum breadth of 75% of the internal breadth of the channel it is inserted in when making a rounded edge bend; and a minimum of 50% of the hollow sheet it is inserted in when doing a sharp edge bend.

2. The system for bending a hollow core sheet of claim 1 wherein said rod is bent to a minimum angle in relation to its length and its relative size ratio to the inside breadth of the channel so as to prevent sliding within the channel.

3. The system for bending a hollow core sheet of claim 1 wherein the hollow core sheet's thickness is multiplied by 0.5 which is then multiplied by the number of bends so as to determine how much shorter the rod needs to be in relation to the length of the hollow core sheet.

4. A method for bending a hollow core sheet wherein at least one rod is bent to a minimum angle in relation to its length and its relative size ratio to the inside breadth of the channel, and then is inserted into a channel forming part of a hollow core sheet so as to prevent sliding within the channel; said at least one rod being calculated as having a maximum breadth of 75% of the internal breadth of the channel it is inserted in when making a rounded edge bend; and calculated to be a minimum of 50% of the thickness of the hollow sheet if it is for doing a sharp edge bend; bending the at least one rod to create a desired shape.

5. The method for bending a hollow core sheet of claim 4 wherein said rod is bent to a minimum angle in relation to its length and its relative size ratio to the inside breadth of the channel so as to prevent sliding within the channel.

6. The method for bending a hollow core sheet of claim 4 wherein the hollow core sheet's thickness is multiplied by 0.5 which is then multiplied by the number of bends so as to determine how much shorter the rod needs to be in relation to the length of the hollow core sheet.
